(19) United States
(12) Patent Application Publication
(10) Pub. No.: US 2011/0303180 A1
(43) Pub. Date: Dec. 15, 2011

(54) Elemental Carbon Lubricant Additive to Suppress Cavitation

(75) Inventors: Patrick Brian Morgan, New Baltimore, MI (US); Dairene Uy, Ypsilanti, MI (US); Scott Michael DeRaad, Ann Arbor, MI (US); Adam John Gryglak, Bloomfield, MI (US); Thomas Kostrzewski, Canton, MI (US)

(73) Assignee: FORD GLOBAL TECHNOLOGIES, LLC, Dearborn, MI (US)

(21) Appl. No.: 12/814,375

(22) Filed: Jun. 11, 2010

(51) Int. Cl. F01M 9/00; F02B 43/00; G10K 11/16; C10M 169/04

(52) U.S. Cl. 123/196 R; 508/113; 123/1 A; 181/296; 977/773; 977/742

(57) ABSTRACT

A method for quieting noise and vibration from a crankcase of an engine comprises dispersing a first amount of elemental carbon in a second amount of lubricant oil to yield a concentrated elemental-carbon suspension. The method further comprises adding the concentrated elemental-carbon suspension in an amount effective to quiet the noise and vibration to a third amount of lubricant oil in the crankcase.

### TECHNICAL FIELD

This application relates to adding an effective amount of elemental carbon to a fully formulated engine oil.

### BACKGROUND AND SUMMARY

In the crankcase lubricant of an internal combustion engine, various additives may be present to improve engine performance, longevity, and fuel economy. Such additives may include detergents and friction modifiers, for example. Accordingly, U.S. Patent Application Publication 2009/0018037 provides a lubricant that includes a base oil, an additive component having a hydroxyl group, and a nanoparticle component such as elemental carbon. This lubricant is alleged to impart a low coefficient of friction between sliding surfaces of an internal combustion engine for improved fuel economy.

The inventors herein have recognized, however, that elemental carbon suspended in the crankcase lubricant of an internal combustion engine can provide benefits completely unrelated to those addressed in the reference above. At suitable concentrations, suspended elemental carbon suppresses the clickity-clack, typewriteresque noise that some engines emit. The inventors' experiments have revealed that this noise is caused by cavitation in the main bearings of the crankcase. Suspended elemental carbon suppresses this cavitation, resulting in reduced engine noise, vibration, and harshness (NVH). Accordingly, the inventors herein have provided, in one embodiment, a lubricant particularly formulated to suppress cavitation. The lubricant formulations here disclosed differ from those of the above reference at least by virtue of the formulation procedure applied and the quantities of elemental carbon suspended in the oil.

Thus, one embodiment provides a method for quieting noise and vibration from a crankcase of an engine. The method comprises dispersing a first amount of elemental carbon in a second amount of lubricant oil to yield a concentrated elemental-carbon suspension. The method further comprises adding the concentrated elemental-carbon suspension in an amount effective to quiet the noise and vibration to a third amount of lubricant oil in the crankcase.

It will be understood that the summary above is provided to introduce in simplified form a selection of concepts that are further described in the detailed description, which follows. It is not meant to identify key or essential features of the claimed subject matter, the scope of which is defined by the claims that follow the detailed description. Further, the claimed subject matter is not limited to implementations that solve any disadvantages noted herein.

### BRIEF DESCRIPTION OF THE DRAWINGS

FIG. 1 schematically shows aspects of an example engine in accordance with an embodiment of this disclosure.

FIG. 2 illustrates an example method for quieting noise and vibration from a crankcase of an engine in accordance with an embodiment of this disclosure.

### DETAILED DESCRIPTION

The subject matter of this disclosure is now described by way of example and with reference to certain illustrated embodiments. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

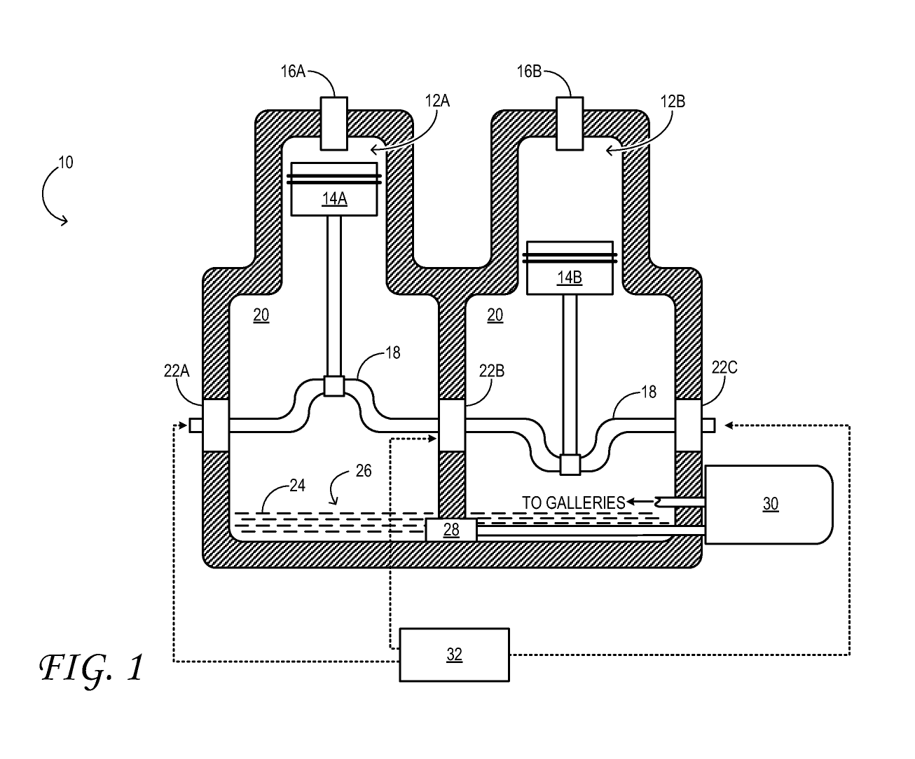

FIG. 1 schematically shows aspects of an example engine 10 in one embodiment. The engine includes cylinders 12A and 12B, with pistons 14A and 14B slidably arranged within the cylinders. The engine may further include suitable componentry 16A and 16B for providing intake air and fuel to the cylinders, for releasing exhaust from the cylinders, and for initiating combustion within the cylinders. In one embodiment, where engine 10 is a gasoline engine, componentry 16A and 16B may include an intake valve, an exhaust valve, a fuel injector, and a spark plug. In another embodiment, where engine 10 is a diesel engine, componentry 16A and 16B may include an intake valve, an exhaust valve, a fuel injector, and a glow plug. For ease of illustration, FIG. 1 shows only two cylinders. It will be understood, however, that this disclosure embraces engines having more or fewer cylinders.

Continuing in FIG. 1, pistons 14A and 14B are mechanically coupled to crankshaft 18, which extends through crankcase 20. The crankshaft is rotationally mounted within the crankcase. More specifically, the crankshaft extends through and rotates within main bearings 22A, 22B, and 22C. Arranged in parallel, the main bearings are fixedly coupled to the crankcase wall. Although FIG. 1 shows three main bearings, this disclosure embraces engines having more or fewer main bearings—as few as two and as many as N+1, where N is the number of cylinders of the engine.

Crankcase 20 includes lubricant 24. The lubricant is partly contained in oil pan 26, which defines the lower interior cavity of the crankcase. Formulated to reduce friction between various parts of engine 10 that slide or roll relative to each other, the lubricant may comprise a lubricant oil in addition to one or more additive components. The lubricant may also be formulated to suppress a noise or vibration from main bearings 22A, 22B, and 22C. To this end, the lubricant may comprise elemental carbon suspended in a lubricant oil, as further described hereinafter.

Returning now to FIG. 1, engine 10 includes oil pump 28 and oil filter 30. The oil pump pumps lubricant 24 from oil pan 26 to oil filter 30, where entrained particulate solids in the lubricant may be transmitted or removed based on their size. From the oil filter, the unremoved portion of the lubricant is delivered to various parts of the engine that require lubrication, via lubricant galleries formed therein, for example. In one embodiment, the oil filter includes a filter element such as filter paper. The filter element may be characterized by a pore size—e.g., a pore diameter or pore length—such that entrained particulate solids larger than the pore size are removed by the filter element, and those smaller than the pore size pass through the filter element. Naturally, the filter element may also be characterized by a range of pore sizes or by one or more effective pore sizes. In any case, the pore size, effective pore size, or range of pore sizes may be large enough to allow the elemental carbon suspended in the lubricant oil to pass through, yet small enough to remove debris. In one embodiment, the range of pore sizes of the oil filter span 15 to 50 micrometers, with narrower sub-ranges contemplated as well.

In addition to engine 10, FIG. 1 also shows NVH probe 32. The NVH probe may be a sensor responsive to a noise or vibration in from a region of the engine. In one embodiment, the NVH probe may be adapted to detect, quantify, and/or indicate a noise or vibration from main bearings 22A, 22B, and/or 22C of the engine. The NVH probe may be used for determining the effective amount of elemental-carbon suspension to be incorporated in the crankcase lubricant to suppress noise and vibration from the crankcase. In one embodiment, the NVH probe may comprise an accelerometer coupled to a part of the engine that receives relatively undamped vibration from the main bearings of the engine. For example, the NVH probe may comprise one or more uniaxial accelerometers coupled to an upper oil pan of the engine. In another embodiment, the NVH probe may comprise a microphone positioned to receive sound originating from the main bearings of the engine; it may comprise two near-field microphones—one on each side of the engine. In these and other embodiments, the NVH probe may be operatively coupled to an engine component responsive to a crank-angle of the engine, such that the sensed noise or vibration may be time-resolved, phase-selected, or otherwise correlated to a predetermined crank angle or range of crank angles of the engine. In these and other embodiments, the NVH probe may be responsive to a predetermined frequency or range of frequencies that correspond to the noise or vibration to be quieted.

The configurations described above enable various methods for quieting noise and vibration from a crankcase of an engine. Accordingly, some such methods are now described, by way of example, with continued reference to above configurations. It will be understood, however, that the methods here described, and others fully within the scope of this disclosure, may be enabled via other configurations as well. The methods presented herein include various measuring and/or sensing events enacted via one or more sensors. The methods also include various computation, comparison, and decision-making events, which may be enacted in an electronic control system operatively coupled to the sensors.

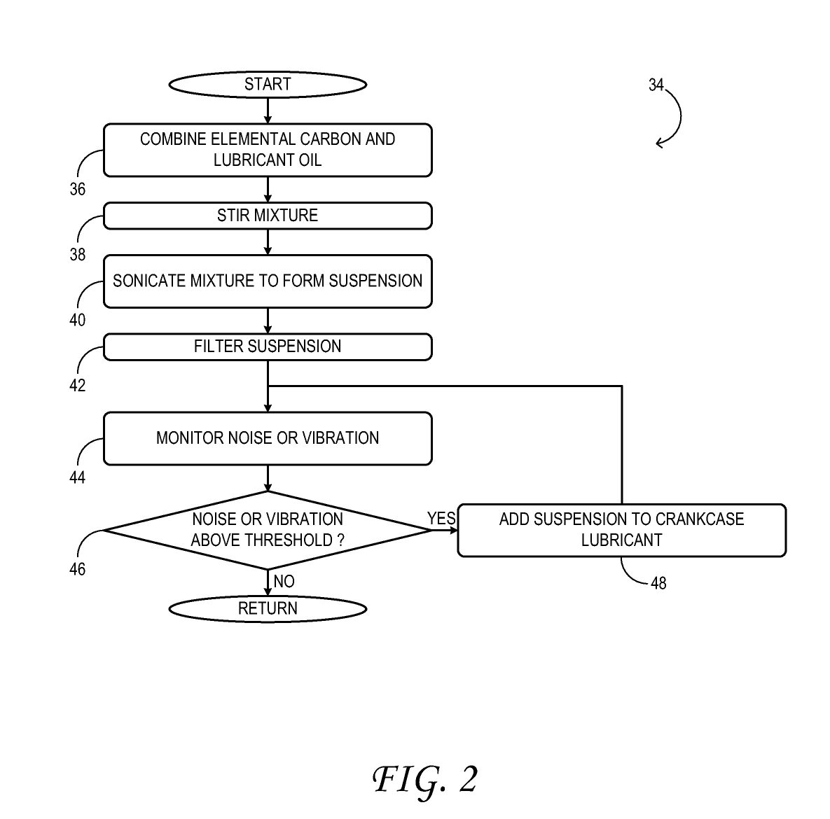

FIG. 2 illustrates method 34 for quieting noise and vibration from a crankcase of an engine. The method comprises dispersing a first amount of elemental carbon in a second amount of lubricant oil to yield a concentrated elemental-carbon suspension. The method further comprises adding the concentrated elemental-carbon suspension in an amount effective to quiet the noise and vibration to a third amount of lubricant oil in the crankcase.

At 36 a measured amount of elemental carbon and a lubricant oil are combined. The elemental carbon may comprise a finely divided solid—soot or carbon black, for example. In one embodiment, the elemental carbon may comprise one or more of carbon nanotubes and/or other carbon nanoparticles. In other embodiments, the elemental carbon may be fully or substantially amorphous. In these and other embodiments, the lubricant oil may comprise a natural, petroleum-based oil or a synthetic oil; it may include just a base oil or be partly or fully formulated—i.e., the lubricant oil may include one or more additive components that impart desirable properties for crankcase lubrication.

At 38 the combined mixture is stirred to encourage a thorough wetting of the elemental carbon by the lubricant oil. At 40 the mixture is sonicated to form a concentrated suspension. (The term ‘concentrated suspension’ is used herein merely to convey that the suspension as prepared may, for convenience, contain more elemental carbon than the lubricant as used.)

In one embodiment, the mixture may be placed in contact with an ultrasonic horn, and the ultrasonic horn energized until all or most of the elemental carbon becomes dispersed in the lubricant oil. Such dispersion may break up aggregates in the elemental carbon to particle sizes small enough to be transmitted through the filter element of oil filter 30 (vide supra). At 42 the suspension is filtered to remove any solids not dispersed. The filter used to remove the solids may have the same or smaller pore size than the oil filter. In other embodiments, the suspension may be spun down in a centrifuge to remove any solids not dispersed. In still other embodiments, the sonication may effect so complete a dispersion of the elemental carbon that removal of undispersed solids is not necessary.

By virtue of the stirring, sonication, and optional filtering as described above, a first amount of elemental carbon is dispersed in a second amount of lubricant oil to form a concentrated suspension. In one embodiment, the first amount relative to the second amount may be determined based on the relative stability of the suspension. Thus, the first amount of elemental carbon suspended in the second amount of lubricant oil may form a stable or metastable suspension, but using a greater first amount or a lesser second amount may yield a less stable suspension. The first amount relative to the second amount may be the greatest amount that will yield a stable or metastable suspension. In another embodiment, the relative first and second amounts may be chosen based on a shelf life of the suspension. Thus, the first amount of elemental carbon suspended in the second amount of lubricant oil may form a transiently stable suspension having a suitable shelf life, but using a greater first amount or a lesser second amount may yield a suspension having a shorter shelf life. The first amount relative to the second amount may be the greatest amount that will yield a suitable shelf life—one year or five years, for example. In one embodiments, the first amount relative to the second amount may be between 0.2 and 0.4 percent by weight. In another embodiment, the first amount relative to the second amount may be 2 percent by weight.

The different embodiments of this disclosure may differ with respect to the balance of the concentrated suspension. In some embodiments, one or more other additives may be present in the suspension—detergents, friction modifiers, or dispersants, for example. In other embodiments, the suspension may lack such additives. In one embodiment, both the lubricant oil and the suspension do not lack a hydroxylated additive, and in others they do.

Subsequent actions in method 34 relate to adding the concentrated elemental-carbon suspension in an amount effective to quiet the noise and vibration to a third amount of lubricant oil in the crankcase. Some embodiments provide that the first amount relative to the combined second and third amounts is determined based on a measurement of noise or vibration from the crankcase while the engine is operating. For example, the suspension may be added to the crankcase portionwise while a noise or vibration from a main bearing of the crankcase is monitored. Accordingly, the first amount relative to the combined second and third amounts may be increased until the noise or vibration is below a threshold, and then increased no further.

In one example, the amount effective of the added concentrated elemental-carbon suspension is an amount effective to reduce noise emanating from main bearings of the engine by 50% (or 3 dB) as compared to before the concentrated elemental-carbon suspension is added, where the noise is at or within a frequency range of sounds heard by the typical human ear.

At 44 of method 34, for example, a noise or vibration from the crankcase is monitored. In one embodiment, the noise or vibration may be monitored using an NVH probe as described hereinabove. The NVH prove may be adapted to monitor the noise or vibration in the particular vicinity of the main bearings of the crankcase, where a clickity-clack, typewriteresque noise may originate due to cavitation. In one embodiment, the monitored noise or vibration may be noise or vibration of a predetermined frequency or range of frequencies. In another embodiment, the monitored noise or vibration may be a noise or vibration that coincides with a predetermined crank angle of the engine or range of crank angles. At 46 it is determined whether noise or vibration is above a threshold level. If the noise or vibration is above the threshold level, then the method advances to 48, where an aliquot of the concentrated suspension is added to the crankcase lubricant to increase the amount of elemental carbon suspended in the lubricant. However, if the noise or vibration is below the threshold level, then the method returns. The threshold level may be set to any suitable value. In one embodiment, however, the threshold level may be set to a value where the clickity-clack, typewriteresque noise is barely detectable to an occupant of a motor vehicle in which the engine is installed.

In the embodiment described above, the first amount relative to the combined second and third amounts may be the minimum amount needed to keep the noise or vibration below a threshold under predetermined engine operating conditions. In this and other embodiments, the amount of the elemental carbon relative to the lubricant oil—viz., the combined second and third amounts—may be between 0.02 and 0.04 percent by weight. In another embodiment, the amount of the elemental carbon relative to the lubricant oil may be 0.03 percent by weight. In yet another embodiment, the amount of elemental carbon relative to the lubricant oil may be as great as 0.5 percent by weight. As described above, the desired final relative amount of elemental carbon may be reached by successively increasing the quantity of elemental carbon in the crankcase lubricant. It is also possible to arrive at the desired final amount starting with a maximum-allowable relative amount of elemental carbon in the lubricant. The crankcase contents may then be diluted while monitoring the NVH. Dilution may be suspended when the monitored NVH exceeds a threshold value.

It will be understood that some of the process steps described and/or illustrated herein may in some embodiments be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, water-treatment systems, and methods disclosed herein, as well as any and all equivalents thereof.

1. A method for quieting noise and vibration from a crankcase of an engine, the method comprising:
dispersing a first amount of elemental carbon in a second amount of lubricant oil to yield a concentrated elemental-carbon suspension; and
adding the concentrated elemental-carbon suspension in an amount effective to quiet the noise and vibration to a third amount of lubricant oil in the crankcase.

2. The method of claim 1, wherein dispersing the first amount of elemental carbon in the second amount of lubricant oil comprises sonicating a mixture of the elemental carbon and the lubricant oil.

3. The method of claim 1, wherein the first amount relative to the combined second and third amounts is determined based on a measurement of the noise or vibration, wherein the amount effective of the concentrated elemental-carbon suspension added is an amount effective to reduce noise emanating from main bearings of the engine by 50% as compared to before the concentrated elemental-carbon suspension is added.

4. The method of claim 3 further comprising increasing the first amount relative to the combined second and third amounts until the noise or vibration is below a threshold.

5. The method of claim 1, wherein the first amount relative to the combined second and third amounts is between 0.02 and 0.04 percent by weight.

6. The method of claim 1, wherein the first amount relative to the second amount is determined based on a stability of the concentrated elemental-carbon suspension.

7. The method of claim 1, wherein the first amount relative to the second amount is 0.2 percent by weight or greater.

8. A crankcase lubricant for an engine, the engine comprising an oil filter with a filter element having a pore size, the lubricant comprising:
a first amount of elemental carbon suspended in a second amount of lubricant oil, the elemental carbon having a particle size less than the pore size; and
a third amount of lubricant oil.

9. The lubricant of claim 8, wherein the elemental carbon comprises a finely divided solid.

10. The lubricant of claim 8, wherein the elemental carbon comprises carbon black.

11. The lubricant of claim 8, wherein the elemental carbon comprises soot.

12. The lubricant of claim 8, wherein the elemental carbon comprises one or more of carbon nanotubes and carbon nanoparticles.

13. The lubricant of claim 8, wherein the first amount of elemental carbon suspended in the second amount of lubricant oil forms a stable suspension.

14. The lubricant of claim 9, wherein the first amount relative to the combined second and third amounts is between 0.02 and 0.04 percent by weight.

15. An engine comprising:
a crankcase;
a main bearing arranged in the crankcase;
a lubricant within the crankcase formulated to suppress a noise or vibration from the main bearing and comprising elemental carbon suspended in a lubricant oil; and
a lubricant filter having a pore size large enough to transmit the elemental carbon suspended in the lubricant oil.

16. The engine of claim 15 further comprising diesel-engine componentry.

17. The engine of claim 15 further comprising gasoline-engine componentry.

18. The engine of claim 15, wherein the elemental carbon comprises carbon black.

19. The engine of claim 15, wherein the elemental carbon comprises soot.

20. The engine of claim 15, wherein an amount of the elemental carbon relative to the lubricant oil is between 0.02 and 0.04 percent by weight.
